(19) United States
(12) Patent Application Publication
(10) Pub. No.: US 2025/0177987 A1
(43) Pub. Date: Jun. 5, 2025

(54) CAPPING AND DECAPPING DEVICE, CAPPING AND DECAPPING SYSTEM AND METHOD OF CAPPING AND DECAPPING A TUBE

(71) Applicant: HOFFMANN-LA ROCHE INC., Little Falls, NJ (US)

(72) Inventors: Rolf CANESSO, Basel (CH); Pascal Markus HOFER, Basel (CH); Thomas ZUMSTEIN, Basel (CH)

(21) Appl. No.: 18/844,164

(22) PCT Filed: Mar. 21, 2023
(86) PCT No.: PCT/EP2023/057164

§ 371 Date: Sep. 5, 2024

(30) Foreign Application Priority Data
Mar. 22, 2022 (EP) 22163441.3

(51) Int. Cl. B01L 3/00; B67B 3/22; B67B 7/00

(52) U.S. Cl. CPC B01L 3/50825; B67B 3/22; B67B 7/00

(57) ABSTRACT

A capping and decapping device for reversibly removing and mounting a cap to and from a tube received in a tube seat of a microplate includes a drum member having a cap stamp, and a frame supporting the drum member such that the drum member is rotatable relative to the frame. The device is configured to rotate the drum member in a first rotational direction when the microplate is moved relative to the frame in a first path direction, and to rotate the drum member in a second rotational direction when the microplate is moved relative to the frame in a second path direction. The cap stamp is configured to remove the cap from the tube when the microplate is moved in the first path direction and is configured to connect the cap to the tube when the microplate is moved in the second path direction.

### TECHNICAL FIELD

The present invention relates to a capping and decapping device and more particularly to a capping and decapping system having such capping and decapping device and a method of capping and decapping a tube by means of such capping and decapping device.

### BACKGROUND ART

In chemical, microbiological and pharmaceutical industry, as well as in chemical, microbiological and pharmaceutical research, standardized microplates are commonly used. In particular, microplate standards developed by the Society for Biomolecular Screening (SBS), the successor organization of which is the Society for Laboratory Automation and Screening (SLAS), and approved by the American National Standards Institute (ANSI) define microplates of 127.76 mm length and 85.48 mm width comprising 96, 384 or 1536 wells or receptacles. The wells or receptacles of such standardized microplates usually have a circular or square shaped cross-section and a flat, rounded or pyramidal, symmetrical bottom.

Further, in many research and development activities, containments such as appropriately dimensioned tubes are filled with fluids, such as chemical or microbiological assays comprising several components for being processed. In order to establish homogenous conditions, frequently said fluids are mixed in the tubes. The tubes can be made of glass, plastic or another suitable material and may be, for example, test tubes, microcentrifuge tubes, capillary tubes, storage tubes, library reformatting tubes, or the like.

For handling and processing tubes, it is known to arrange the tubes in microplates equipped with appropriate wells or receptacles as tube seats. In particular, typically each tube seat is configured to receive one tube. In this context, the standardized microplates as mentioned above can be particularly beneficial as they allow for using equipment adapted or configured in accordance with the respective standards. For example, it is possible to efficiently use robotic arrangements in many applications of microplates. Thereby, not only the defined size and location of the wells or receptacles but also, e.g., cut away corners in accordance with the standards enable an error-free positioning or orientation of the microplates. Particularly, when it is desired to involve microplates in automated processes or automated process steps, such standardized microplates are beneficial.

For protecting substances or samples inside of tubes, it is known to seal the open ends of the tubes with foils or a similar structure. For example, JP 2013 244969 A describes blood collecting vessel plugging apparatus. For accessing the substance or sample inside a tube the foil has then to be teared off the tube or pierced such that its interior is accessible. In this context, when comparably small tubes such as tubes for microplates with 384 or 1536 wells or receptacles are involved, such known sealing or closing and opening of the tubes is comparably difficult. Usually, the tubes and the foils are disposed after being used or processed.

For improving the situation in this connection, microplate systems have been developed which comprises a standardized microplate with seats and a plurality of containments. Each of the containments comprises a tube shaped to be held in a seat of the microplate and a removable cap. In an embodiment, the caps are configured to be press fitted in or on the tubes. In use, the caps may repeatedly be opened and closed by providing the caps on the tubes and by removing or pulling the caps from the tubes.

Even though such microplate systems allow for an efficient handling and operation of tubes, it is often required to open and or close plural or all tubes arranged in a microplate. When using known standard equipment, e.g. standard handling robots, such capping and decapping can be cumbersome.

Therefore, there is a need for a device allowing efficient capping and decapping of tubes in a microplate, particularly, in a standardized microplate having 96, 384 or 1536 wells, receptacles or tube seats.

### Disclosure of the Invention

According to the invention this need is settled by a capping and decapping device as it is defined by the features of independent claim 1, by a capping and decapping system as it is defined by the features of independent claim 9, and by a method as it is defined by the features of independent claim 15. Preferred embodiments are subject of the dependent claims.

In one aspect, the invention is a capping and decapping device for reversibly removing and mounting of a cap to and from a tube received in a tube seat of a microplate. The capping and decapping device comprises a drum member having a cap stamp and a frame structure. The frame structure supports the drum member such that the drum member is rotatable about a rotational axis relative to the fame structure.

The capping and decapping device is configured to rotate the drum member in a first rotational direction when the microplate receiving the tube is moved relative to the frame along a predefined path in a first path direction. Further, the capping and decapping device is configured to rotate the drum member in a second rotational direction when the microplate receiving the tube is moved relative to the frame structure along the predefined path in a second path direction. Thereby, the first rotational direction is opposite to the second rotational direction and the first path direction is opposite to the second path direction. For example, if the first rotational direction is clock-wise, the second rotational direction is counter-clock-wise.

The cap stamp is configured to remove the cap from the tube when the microplate receiving the tube is moved in the first path direction along the predefined path. Further, the cap stamp is configured to connect the cap to the tube when the microplate receiving the tube is moved in the second path direction along the predefined path.

The predefined path can particularly be a linear path extending below the drum member. Such path allows for an efficient operation of the capping and decapping device and, particularly, an efficient interaction between the microplate and the drum member for capping and decapping.

The microplates involved in the invention can be microplates in accordance with a standard developed by the Society for Biomolecular Screening (SBS), the successor organization of which is the Society for Laboratory Automation and Screening (SLAS), and approved by the American National Standards Institute (ANSI).

Particularly, such standards define microplates of 127.76 mm length and 85.48 mm width comprising 96, 384 or 1536 wells or receptacles.

More specifically, the microplate involved in the invention advantageously may have a predefined length and a predefined width. Thereby, the length may be in a range between about 127 mm and about 129 mm, between about 127.3 mm and about 128.3 mm or between 127.26 mm and 128.26 mm, or of about 127.76 mm. The width may be in a range between about 84 mm and about 86 mm, between about 84.9 mm and about 86 mm or between 84.98 mm and 85.98 mm, or of about 85.48 mm.

The invention can be advantageous for microplates having 96 and, particularly, 384 or 1536 receptacles or wells. In such microplates the wells or receptacles and, thus, the tubes involved have a comparably small size such that they are comparably difficult to close. Thus, (semi) automatically capping or decapping such tubes in accordance with the invention is particularly beneficial.

When the microplate receiving the tube is moved in the first path direction such that the drum member is rotated in the first rotational direction and when the microplate receiving the tube is moved in the second path direction such that the drum member is rotated in the second rotational direction, the cap stamp of the drum member may be moved about the rotational axis relative to the microplate. Like this, the cap stamp can approach and move away of the tube received by the microplate. Thereby, depending on the direction of rotation, the cap stamp can either hold the cap for taking it off the tube (decapping) or set the cap into the tube (capping). Like this, a particularly efficient mounting of the cap to the tube or removal of the cap from the tube can be implemented. Further, by the rotational movement of the drum member, it can be prevented that the tube is lifted relative to the microplate and, thereby, eventually removed from the microplate.

Preferably, the capping and decapping device comprises a guiding arrangement configured to define the movement of the microplate along the predefined path. Such guiding arrangement allows to predefine the movement of the microplate such that a well coordinated cooperation between microplate, tube and drum member can be established.

Thereby, the guiding arrangement preferably has a carriage with a microplate seat configured to receive the microplate. The microplate seat allows to precisely arrange the microplate at a predefined position and orientation.

In one embodiment, each of the carriage and the drum member are equipped with a drive such as an electric motor. The two drives are synchronized such that the carriage is moved in correspondence with the drum member. In this embodiment, the capping and decapping device can be operated in a fully automatic manner.

The guiding arrangement preferably comprises a pathing component extending along the predefined path, wherein the carriage is coupled to the pathing component such that the carriage is movable along the pathing component. The pathing component can comprise one or more rails or a similar element configured to exactly set the predefined path.

The carriage of the guiding arrangement preferably has a height adjustment structure configured to manipulate the microplate seat to adjust a height or distance between the microplate and the drum member, when the microplate is received in the microplate seat. Like this, microplates of different height and/or tubes of different lengths can be processed in the same capping and decapping device.

Preferably, the capping and decapping device comprises a rotator arrangement configured to rotate the drum member when the microplate is moved along the predefined path. In particular, the rotator arrangement can be designed to actively rotate the drum member in coordination with the movement of the microplate. Such active rotation can be induced by one or more specific motors or similar drives, or induced by the movement of the microplate. In case of the plural motors, the motors advantageously are synchronized to achieve proper and efficient operation.

Thereby, the rotator arrangement preferably comprises a toothed rack and a gearwheel mounted to the drum member, wherein the toothed rack engages the gearwheel such that the drum member is rotated when the toothed rack moves relative to the drum member. Advantageously, the toothed rack extends at least partially along the predefined path. Further, in an advantageous embodiment, the gearwheel is stationary with the drum member. Such interacting toothed rack and gearwheel allow for efficiently and directly transforming the typically linear or translational movement of the microplate into a rotary movement of the drum member. In particular, such arrangement can be beneficial in manual embodiments of the capping and decapping device. Moreover, the first path direction can be securely coupled or associated to the first rotational direction and the second path direction to the second rotational direction.

Preferably, the toothed rack of the rotator arrangement is fixed to the carriage of the guiding arrangement. Like this, the toothed rack can be stationary in relation to the microplate seat of the carriage such that a movement of the microplate arranged in the microplate seat simultaneously and identically moves the toothed rack.

Preferably, the drum member has a drum body and the cap stamp radially extends from the drum body. Such design of the drum member allows for efficiently move the cap stamp in a vertical direction, or towards and off the tube received in the microplate. Thereby, the cap stamp can interact with the tube in order to provide the cap to the tube or to remove the cap from the tube.

Preferably, the cap stamp is configured to engage the cap when the microplate receiving the tube is moved in the first path direction such that the cap is removed from the tube by the drum member rotating in the first rotational direction, and to disengage the cap when the microplate receiving the tube is moved in the second path direction such that the cap is mounted to the tube by the drum member rotating in the second rotational direction. Such configuration of the cap stamp allows for efficiently capping the tube in the microplate by moving the microplate along the first path direction and decapping the tube by moving the microplate in the second path direction.

Preferably, the drum member comprises a line of plural cap stamps including the cap stamp. By means of such line of cup stamps a plurality of tubes arranged in a plurality of tubes seats in the microplate can be capped or decapped at once. This allows for efficiently cap removal and provision when a multi well microplate is used for handling multiple tubes.

Thereby, the drum member preferably comprises at least one further line of plural cap stamps. By such design at least two lines of tubes or an array of tubes arranged in a multi well microplate can efficiently be capped and decapped line by line.

In another aspect, the invention is a capping and decapping system comprising a capping and decapping device as described above, a microplate equipped with at least one tube seat, at least one tube received in the at least one tube seat of the microplate, and at least one cap associated to the at least one tube received in the at least one tube seat of the microplate.

By means of the capping and decapping system according to the invention and its preferred embodiments described below, the effects and benefits of the capping and decapping device and its preferred embodiments described above can efficiently be achieved.

The at least one cup and the at least one tube can be embodied for any suitable connection allowing an efficient reversible and sufficiently tight closing of the tube. Preferably, the at least one cap comprises a first press-fit structure and the at least one tube comprises a second press-fit structure corresponding to the first press-fit structure of the cap.

The term “press-fit” as used in this connection relates to an interference fit or friction fit being a form of fastening between tight fitting mating parts, i.e. the cap and the tube, that produces a joint which is held together by friction, particularly after the parts are pushed together. The first and second press-fit structures can involve an elastic portion, e.g., of the cap and a rigid portion, e.g. of the tube, which are abutting when the cap is connected to the tube.

By providing the cap and the tube with corresponding press-fit structures, the cap can efficiently be mounted or connected to the tube by being pushed into the tube or the like. Likewise, it can efficiently be de-mounted or removed from the tube by being pulled out of the tube. In particular, such pushing and pulling can be provided along the longitudinal axis of the tube.

Thereby, the first press-fit structure of the cap preferably is pressed against the second press-fit structure of the tube, when the cap and the tube are connected. By means of such pressing the friction forces applied can be sufficient to securely hold the cap in the tube. For example, such pressing can be achieved by providing either one of the cap or the tube, or even a section thereof, of an elastically deformable material. Thereby, advantageously the cap is made of a comparably elastic and soft material and the tube is made of a comparably rigid material.

The first press-fit structure of the cap may comprise a sealing bulge at an outer circumference of the cap. Such sealing bulge can, e.g., provide elasticity to be deformed when the cap is connected to the tube. By means of such a sealing bulge, the tube can be tightly closed such that the interior of the tube can be safely sealed.

The at least one cap preferably comprises a snap cavity with an opening accessible when the at least one cap is connected to the tube. Such snap cavity allows for an efficient snap-fit connection.

Thereby, the snap cavity of the at least one cap has a first snap-fit structure, a front side of the cap stamp of the drum member facing in the first rotational direction is equipped with a second snap-fit structure mating the first snap-fit structure of the snap cavity of the at least one cap, and wherein a back side of the cap stamp of the drum member facing in the second rotational direction is free of any snap-fit structure mating the first snap-fit structure of the snap cavity of the at least one cap.

The first and second snap-fit structures allow for providing a form fit connection between the cap stamp and the cap. In particular, when the drum member rotates the cap stamp in the first rotational direction, the cap stamp can be moved into the snap cavity of the cap and the first snap-fit structure engages the second snap-fit structure. By further rotating the drum member in the first rotational direction, the cap stamp moves away from the tube. Thereby, the connection provided by the first and second snap-fit structures allows the cap stamp to remove the cap from the tube. Furthermore, when the drum member rotates the cap stamp in the second rotational direction, the cap stamp holding the cap can be moved into the snap cavity of the cap such that the cap is connected to the tube. By further rotating the drum member in the second rotational direction, the cap stamp moves away from the tube. Thereby, since the back side of the cap stamp is free of any snap-fit structure, the connected to the tube is removed from the cap stamp.

Preferably, (i) the front side of the cap stamp of the drum member of the capping and decapping device is connected to the at least one cap at a first force, when the cap stamp is arranged in the snap-fit cavity of the at least one cap, (ii) the at least one cap is connected to the at least one tube at a second force, when the at least one cap is connected to the at least one tube, and (iii) the back side of the cap stamp of the drum member of the capping and decapping device is connected to the at least one cap at a third force, when the cap stamp is arranged in the snap-fit cavity of the at least one cap. The first force is greater than the second force and the second force is greater than the third force. By configuring the cap, tube and cap stamp accordingly an efficient removal and connection of the cap from and to the tube by means of a rotational movement of the cap stamp can be achieved.

The first snap-fit structure of the snap cavity of the at least one cap comprises an undercut and the second snap-fit structure of the cap stamp comprises a projection mating the undercut. Such projection and undercut allow for a comparably solid form fit connection such that it can be achieved that the first force is stronger than the second and third forces.

Thereby, the undercut of the first snap-fit structure of the snap cavity of the at least one cap preferably extends over the complete inner circumference of the snap cavity of the at least one cap. Such arrangement allows for an efficient appropriate interaction with the cap stamp irrespective of the rotational position of the cap relative to the tube.

Preferably, in the capping and decapping system the microplate comprises a plurality of identical tube seats including the tube seat, wherein the plurality of tube seats is arranged in a first number of lines each having a second number of the plurality of tube seats, wherein the drum member has a plurality of identical cap stamps including the cap stamp, and wherein the plurality of cap stamps is arranged the first number of lines each having the second number of the plurality of cap stamps.

The plural tube seats typically are identical by being essentially identically formed, shaped and dimensioned. Likewise, the plural cap stamps are identical by being essentially identically formed, shaped and dimensioned.

Thereby, the microplate preferably has a length in a range between about 127 mm and about 129 mm, between about 127.3 mm and about 128.3 mm or between 127.26 mm and 128.26 mm, or of about 127.76 mm, the microplate preferably has a width in a range between about 84 mm and about 86 mm, between about 84.9 mm and about 86 mm or between 84.98 mm and 85.98 mm, or of about 85.48 mm, and the microplate preferably has 384 or 1536 tube seats.

The microplate can particularly be configured to meet microplates standards of the American National Standards Institute (ANSI) and the Society for Laboratory Automation and Screening (SLAS), i.e. ANSI/SLAS 1-2004: Microplates—Footprint Dimensions; ANSI/SLAS 3-2004: Microplates—Bottom Outside Flange Dimensions; and ANSI/SLAS 4-2004: Microplates—Well Positions. For example, when being equipped with 384 receptacles, the receptacles can be regularly arranged in sixteen rows of twenty-four receptacles.

In a further other aspect, the invention is a method of capping and decapping a tube, comprising the steps of: obtaining a capping and decapping device as described above; obtaining a microplate equipped with at least one seat, wherein at least one tube is received in the at least one seat of the microplate and at least one cap is associated to the at least one tube received in the at least one seat of the microplate; and moving the microplate receiving the at least one tube relative to the frame of the capping and decapping device along the predefined path, wherein, for decapping, the microplate receiving the at least one tube is moved in the first direction below the drum member such that the drum member is rotated in the first rotational direction and the cap stamp removes the at least one cap from the at least one tube, and for capping, the microplate receiving the at least one tube is moved in the second direction below the drum member such that the drum member is rotated in the second rotational direction and the cap stamp connects the at least one cap to the at least one tube.

The method according to the invention allows to efficiently achieve and implement the effects and benefits of the capping and decapping device and its preferred embodiments describes above as well as of the capping and decapping system and its preferred embodiments described above.

### BRIEF DESCRIPTION OF THE DRAWINGS

The capping and decapping device according to the invention, the capping and decapping system according to the invention and the method according to the invention are described in more detail hereinbelow by way of an exemplary embodiment and with reference to the attached drawings, in which:

FIG. 1 shows a perspective view of an embodiment of a capping and decapping system according to the invention comprising an embodiment of a capping and decapping device according to the invention;

FIG. 2 shows an enlarged perspective view of a section of the capping and decapping system of FIG. 1;

FIG. 3 shows a side view of cap stamp of a drum member of the capping and decapping device of the capping and decapping system of FIG. 1;

FIG. 4 shows a perspective view of a section of a stamp rod with the cap stamp of FIG. 3 being provided with caps; and

FIG. 5 shows an enlarged perspective view of one cap stamp of the stamp rod of FIG. 4, wherein the cap of this cap stamp is cut.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

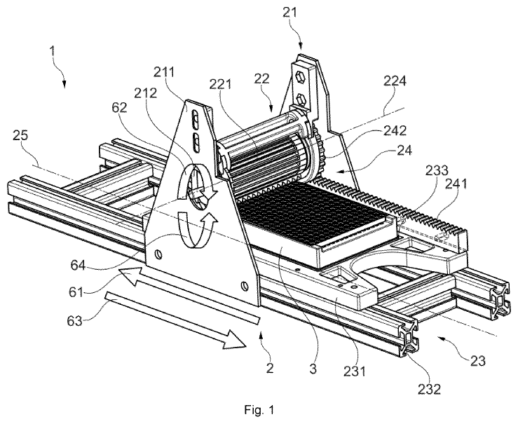

FIG. 1 shows an embodiment of a capping and decapping system 1 according to the invention comprising a capping and decapping device 2 according to the invention and a microplate 3. The capping and decapping device has a frame 21 as frame structure, a drum member 22, a guiding arrangement 23, and a rotator arrangement 24.

The frame 21 has two sidewalls 211, each equipped with a bearing 212. The bearings 212 of the frame 21 hold and support a drum body 221 of the drum member 22 between the two sidewalls 211. Thereby, the drum member 22 is rotatable relative to the sidewalls 211 about a longitudinal axis of the drum body 221 such that the longitudinal axis of the drum body 221 is the rotational axis 224 of the drum member 22.

The guiding arrangement 23 has two parallel rails 232 as pathing components and a carriage 231 arranged on the rails 232 such that the carriage 231 is linearly movable along the rails 232. Thereby, the rails 232 define a predefined path 25 along which the carriage 231 is movable. More specifically, the carriage 231 can be moved in a first path direction 61 along the rails 232, in FIG. 1 this is a direction to the left, and in a opposite second path direction 63, in FIG. 1 this is a direction to the right. The carriage 231 is equipped with a microplate seat 233 receiving the microplate 3 in a predefined position and orientation. Each of the sidewalls 211 is fixed to one of the rails 232.

The rotator arrangement 24 comprises a longitudinal toothed rack 241 and a gearwheel 242. The toothed rack 241 is stationarily mounted to the carriage 231 of the guiding arrangement 23. The gearwheel 242 is stationarily mounted to the drum body 221 of the drum member 22. The toothed rack 241 and the gearwheel 242 engage such that a movement of the carriage 231 and of the microplate 3 in the microplate seat 233 of the carriage 231 along the rails 232 induces a rotation of the drum member 22. More specifically, moving the carriage 231 in the first path direction 61 induces a rotation of the drum member 22 in a first rotational direction 62, in FIG. 1 this is a clockwise rotational direction, and moving the carriage 231 in the second path direction 63 induces a rotation of the drum member 22 in a second rotational direction 64, in FIG. 1 this is a counter-clockwise rotational direction.

The microplate 3 has a length of about 127.76 mm, a width of about 85.48 mm, and three hundred eighty-four wells 31 arranged in twenty-four lines of sixteen wells 31. More specifically, the microplate is designed in compliance with the microplates standards ANSI/SLAS 1-2004: Microplates—Footprint Dimensions; ANSI/SLAS 3-2004: Microplates—Bottom Outside Flange Dimensions; and ANSI/SLAS 4-2004: Microplates—Well Positions as provided by of the American National Standards Institute (ANSI) and the Society for Laboratory Automation and Screening (SLAS).

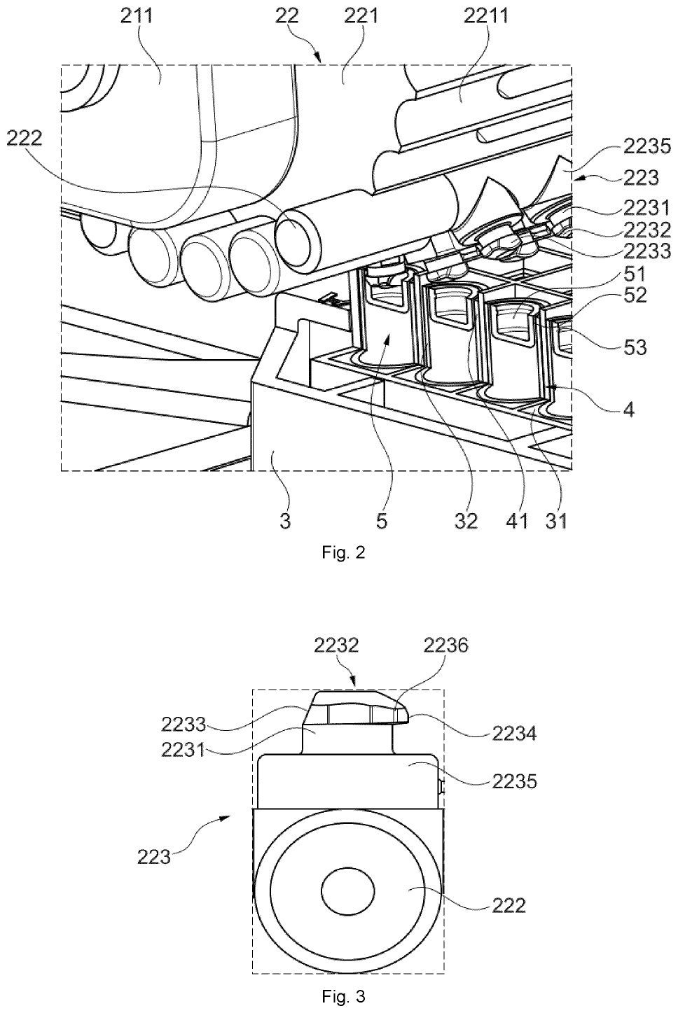

As can be seen in FIG. 2, each well 31 of the microplate 3 forms a tube seat 32. The capping and decapping system 1 further comprises a plurality of glass tubes 4 and a plurality of elastic caps 5. Each tube 4 is essentially cylindrically shaped and is received in one of the tube seats 32 of the microplate 3. An upper open end of each tube 4 is closed by one of the caps 5. In particular, the caps 5 are pressed into the open ends of the tubes 4 in a plug-like manner. Thereby, an outer circumferential bulge of each cap 5 together with the elasticity of the material the cap is made of form a first press-fit structure 52 and the interior surface of the rigid cylindric wall of the associated tube 4 forms a second press-fit structure 41. The caps 5 are press-fitted into the tubes 4 and the first press-fit structures 52 interacting with the second press-fit structures 41 establish tight closure of the tubes 4. Thereby, the caps 5 are held in the tubes 4 at a second force. The caps 5 have hollow interiors opening in an upward direction, thereby forming snap cavities 51 accessible top down. The snap cavity 51 of each cap 5 is provided with a circumferential internal bulge establishing an undercut 53 extending into the snap cavity 51.

The drum member 22 comprises twenty-four stamp rods 222. Further, the drum body 221 is equipped with twenty-four rod recesses 2211 coaxially extending to the longitudinal axis of the drum body 221. For illustration purposes, not all rod recesses 2211 depicted in FIG. 2 are provided with stamp rods 222. The rod recesses 2211 have a partial cylindric indentation in the outer circumference of the drum body 221 and a longitudinal bar slit.

Each stamp rod 222 is monolithically embodied with sixteen cap stamps 223 radially extending from the drum body 221. Each cap stamp 223 has a cylindrical stamp body 2235 passing over into a cylindrical neck 2231 of reduced diameter compared to the stamp body 2235. The neck 2231 again passes over into a head 2232.

As can be best seen in FIG. 3, the head 2232 of each cap stamp 223 forms a front side 2234 and an opposite back side 2233 of the respective cap stamp 223. In particular, at the front side 2234 the head 2232 protrudes the neck 2231 such that a projection 2236 is formed by the head 2232 as a second snap-fit structure. In contrast, at the back side 2233 the head 2232 has a slanted flat surface and does not protrude the neck 2231 but reduces in diameter in an upward direction. Thus, the back side 2233 is free of any snap-fit structure.

As can be best seen in FIG. 1 and FIG. 2, the back sides 2233 of the cap stamps 223 face in the second rotational direction 64. The front sides 2234 of the cap stamps 223 face in the first rotational direction 62.

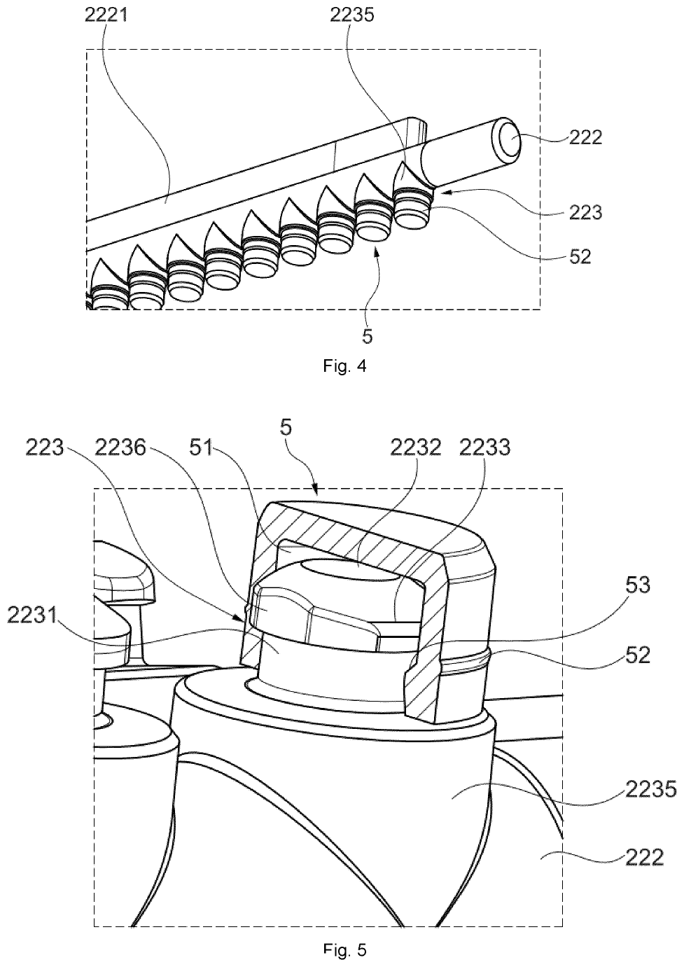

In FIG. 4, the stamp rod 222 is depicted in an unmounted state. Thereby, it can be seen that the stamp rod 222 has a bar 2221 extending along the stamp rod 222. The bar 2221 is shaped to mate the bar slit of the rod recess 2211 of the drum body 221. In particular, when being arranged in the rod recess 2211, the bar 2221 of the stamp rod 222 is received in the bar slit of the rod recess 2211 such that the stamp rod 222 and the cap stamps 223 are exactly positioned and oriented to the drum body 221 when being received in the rod recess 2211. In FIG. 4, each cap stamp 223 holds one cap 5. In particular, the caps 5 are held by the cap stamps 223 being arranged in the snap cavities 51.

FIG. 5 shows one of the cap stamps 223 arranged in the snap cavity 51 of one of the caps 5. The projection 2236 of the cap stamp 223 mates the undercut 53 of the cap 5. In particular, a bottom end of the projection 2236 abuts a top end of the undercut 53. Thereby, the slanted shape of the undercut 53 and the elasticity of the cap 5 define a first force by which the cap 5 is connected to the cap stamp 223 at the front side 2234. The back side 2233 of the cap stamp 223 is connected to the cap 5 at a third force. The first force of the connection between the front side 2234 of the cap stamp 223 and the cap 5 is higher than the second force between the cap 5 and the tube 4, which in turn is higher than the third force between the back side 2233 of the cap stamp 223 and the cap 5.

In operation of the capping and decapping system 1, for decapping, the microplate 3 receiving the tubes 4 provided with caps 5 is held in the microplate seat 233 of the carriage 231 and is moved in the first direction 61 along the rails 232 below the drum member 22. By means of the toothed rack 241 and the gearwheel 242, the drum member 22 is simultaneously rotated in the first rotational direction 62. Thereby, one line of cap stamps 223 after the other is downwardly moved into the snap cavities 51 of one line of caps 5 after the other thereby engaging the caps 5. By further rotating the drum member 22 in the first rotational direction 62 one line of cap stamps 223 after the other is upwardly moved relative to the tubes 4 and the microplate 3. At that stage, the connection at the front side 2234 of the cap stamps 223 provides a connection between the caps 5 and the cap stamps 223 at the first force. Since the first force is higher than the second force connecting the caps 5 to the tubes 4, the caps 5 are upwardly moved together with the cap stamps 223 and removed from the tubes 4. Thus, the tubes 4 are decapped and, at the same time, lifting of the tubes 4 out of the microplate seats 233 is prevented.

For capping, the microplate 3 with the open tubes 4 held in the microplate seat 233 of the carriage 231 is moved in the second direction 63 along the rails 232 below the drum member 22. Again, by means of the toothed rack 241 and the gearwheel 242, the drum member 22 is simultaneously rotated in the second rotational direction 64. Thereby, one line of cap stamps 223 provided with the caps 5 is downwardly moved into the tubes 4 of one line of tubes 4 after the other. By further rotating the drum member 22 in the second rotational direction 64 one line of cap stamps 223 after the other is upwardly moved relative to the tubes 4 and the microplate 3. At that stage, the connection at the back side 2233 of the cap stamps 223 provides a connection between the caps 5 and the cap stamps 223 at the third force. Since the third force is lower than the second force connecting the caps 5 to the tubes 4, the caps 5 are held in the tubes 4 and the cap stamps 23 are upwardly moved disengaging the caps 5. Thus, the tubes 4 are capped.

This description and the accompanying drawings that illustrate aspects and embodiments of the present invention should not be taken as limiting—the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the FIGS. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A capping and decapping device for reversibly removing and mounting of a cap to and from a tube received in a tube seat of a microplate, comprising
a drum member having a cap stamp, and
a frame structure supporting the drum member such that the drum member is rotatable about a rotational axis relative to the frame structure,
wherein the capping and decapping device is configured to rotate the drum member in a first rotational direction when the microplate receiving the tube is moved relative to the frame structure along a predefined path in a first path direction, and to rotate the drum member in a second rotational direction when the microplate receiving the tube is moved relative to the frame structure along the predefined path in a second path direction,
wherein the first rotational direction is opposite to the second rotational direction and the first path direction is opposite to the second path direction,
wherein the cap stamp is configured to remove the cap from the tube when the microplate receiving the tube is moved in the first path direction along the predefined path, and
wherein the cap stamp is configured to connect the cap to the tube when the microplate receiving the tube is moved in the second path direction along the predefined path.

2. The capping and decapping device of claim 1, comprising a guiding arrangement configured to define the movement of the microplate along the predefined path.

3. The capping and decapping device of claim 2, wherein the guiding arrangement has a carriage with a microplate seat configured to receive the microplate, wherein the carriage preferably has a height adjustment structure configured to manipulate the microplate seat to adjust a distance between the microplate and the drum member.

4. The capping and decapping device of claim 3, wherein the guiding arrangement comprises a pathing component extending along the predefined path, wherein the carriage is coupled to the pathing component such that the carriage is movable along the pathing component.

5. (canceled)

6. The capping and decapping device of claim 1, comprising a rotator arrangement configured to rotate the drum member when the microplate is moved along the predefined path.

7. The capping and decapping device of claim 6, wherein a guiding arrangement has a carriage with a microplate seat configured to receive the microplate, wherein the rotator arrangement comprises a toothed rack and a gearwheel mounted to the drum member, wherein the toothed rack engages the gearwheel such that the drum member is rotated when the toothed rack moves relative to the drum member.

8. The capping and decapping device of claim 7, wherein the toothed rack of the rotator arrangement is fixed to the carriage of the guiding arrangement.

9. The capping and decapping device of claim 1, wherein the drum member has a drum body and the cap stamp radially extends from the drum body.

10. The capping and decapping device of claim 1, wherein the cap stamp is configured
to engage the cap when the microplate receiving the tube is moved in the first path direction along the predefined path such that the cap is removed from the tube by the drum member rotating in the first rotational direction, and
to disengage the cap when the microplate receiving the tube is moved in the second path direction along the predefined path such that the cap is mounted to the tube by the drum member rotating in the second rotational direction.

11. The capping and decapping device of claim 1, wherein the drum member comprises a line of plural cap stamps including the cap stamp, wherein the drum member preferably comprises at least one further line of plural cap stamps.

12. (canceled)

13. A capping and decapping system comprising:
a capping and decapping device of claim 1,
a microplate equipped with at least one tube seat,
at least one tube received in the at least one tube seat of the microplate, and
at least one cap associated to the at least one tube received in the at least one tube seat of the microplate.

14. The capping and decapping system of claim 13, wherein the at least one cap comprises a first press-fit structure and the at least one tube comprises a second press-fit structure corresponding to the first press-fit structure (52) of the cap.

15. The capping and decapping system of claim 13, wherein the at least one cap comprises a snap cavity with an opening accessible when the at least one cap is connected to the tube.

16. The capping and decapping system of claim 15,
wherein the snap cavity of the at least one cap has a first snap-fit structure,
wherein a front side of the cap stamp of the drum member facing in the first rotational direction is equipped with a second snap-fit structure mating the first snap-fit structure of the snap cavity of the at least one cap, and
wherein a back side of the cap stamp of the drum member facing in the second rotational direction is free of any snap-fit structure mating the first snap-fit structure of the snap cavity of the at least one cap.

17. The capping and decapping system of claim 16,
wherein the front side of the cap stamp of the drum member of the capping and decapping device is connected to the at least one cap at a first force, when the cap stamp is arranged in the snap cavity of the at least one cap,
wherein the at least one cap is connected to the at least one tube at a second force, when the at least one cap is connected to the at least one tube,
wherein the back side of the cap stamp of the drum member of the capping and decapping device is connected to the at least one cap at a third force, when the cap stamp is arranged in the snap cavity of the at least one cap, and
wherein the first force is greater than the second force and the second force is greater than the third force.

18. The capping and decapping system of claim 16, wherein the first snap-fit structure of the snap cavity of the at least one cap comprises an undercut and the second snap-fit structure of the cap stamp comprises a projection mating the undercut.

19. The capping and decapping system of claim 18, wherein the undercut of the first snap-fit structure of the snap cavity of the at least one cap extends over the complete inner circumference of the snap cavity of the at least one cap.

20. The capping and decapping system of claim 13,
wherein the microplate comprises a plurality of identical tube seats including the tube seat,
wherein the plurality of tube seats is arranged in a first number of lines each having a second number of the plurality of tube seats,
wherein the drum member has a plurality of identical cap stamps including the cap stamp, and
wherein the plurality of cap stamps is arranged in the first number of lines each having the second number of the plurality of cap stamps.

21. The capping and decapping system of claim 20, wherein
the microplate has a length in a range between about 127 mm and about 129 mm, between about 127.3 mm and about 128.3 mm or between 127.26 mm and 128.26 mm, or of about 127.76 mm,
the microplate has a width in a range between about 84 mm and about 86 mm, between about 84.9 mm and about 86 mm or between 84.98 mm and 85.98 mm, or of about 85.48 mm, and
the microplate has 96, 384 or 1536 tube seats.

22. A method of capping and decapping a tube, comprising
obtaining a capping and decapping device according to claim 1,
obtaining a microplate equipped with at least one tube seat, wherein at least one tube is received in the at least one tube seat of the microplate and at least one cap is associated to the at least one tube received in the at least one tube seat of the microplate, and
moving the microplate receiving the at least one tube relative to the frame of the capping and decapping device along the predefined path, wherein,
for decapping, the microplate receiving the at least one tube is moved in the first direction below the drum member such that the drum member is rotated in the first rotational direction and the cap stamp removes the at least one cap from the at least one tube, and
for capping, the microplate receiving the at least one tube is moved in the second direction below the drum member such that the drum member is rotated in the second rotational direction and the cap stamp connects the at least one cap to the at least one tube.
